(19) United States
(12) Patent Application Publication
(10) Pub. No.: US 2022/0334261 A1
(43) Pub. Date: Oct. 20, 2022

(54) LIDAR SYSTEM EMITTING VISIBLE LIGHT TO INDUCE EYE AVERSION

(71) Applicant: Continental Automotive Systems, Inc., Auburn Hills, MI (US)

(72) Inventor: Sean H. Ross, Tucson, AZ (US)

(73) Assignee: Continental Automotive Systems, Inc., Auburn Hills, MI (US)

(21) Appl. No.: 17/301,940

(22) Filed: Apr. 20, 2021

(51) Int. Cl. G01S 17/931; G01S 7/481; G01S 17/89; B60Q 1/00; B60Q 1/04

(52) U.S. Cl. CPC G01S 17/931; G01S 7/4813; G01S 7/4815; G01S 17/89; G01S 7/4816; B60Q 1/0023; B60Q 1/04

(57) ABSTRACT

A lidar system includes a light detector having a field of view. The lidar system includes one or more light emitters. At least one of the one or more light emitters emits infrared light into the field of view of the light detector and at least one of the one or more light emitters emits visible light into the field of view of the light detector. The visible light emitted from the lidar system encourages eye aversion, e.g., by pedestrians, vehicle occupants, etc., to reduce the likelihood of eye exposure to the infrared light emitted by the lidar system.

### BACKGROUND

A lidar system includes a photodetector, or an array of photodetectors. Light is emitted into a field of view of the photodetector. The photodetector detects light that is reflected by an object in the field of view. For example, a flash lidar system emits pulses of light, e.g., laser light, into essentially the entire the field of view. The detection of reflected light is used to generate a 3D environmental map of the surrounding environment. The time of flight of the reflected photon detected by the photodetector is used to determine the distance of the object that reflected the light.

The lidar system may be mounted on a vehicle to detect objects in the environment surrounding the vehicle and to detect distances of those objects for environmental mapping. The output of the lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

### BRIEF DESCRIPTION OF THE DRAWINGS

FIG. 1 is a perspective view of a vehicle having a lidar system.

FIG. 2 is a front view of the vehicle showing the lidar system assembled to a headlight assembly of the vehicle.

FIG. 3 is a perspective view of the lidar system.

FIG. 4 is a cross section of one example of the lidar system.

FIG. 5 is a cross section of another example of the lidar system.

FIG. 6 is a cross section of another example of the lidar system.

FIG. 7 is a perspective view of components of a light-receiving system of the lidar system.

FIG. 7A is an enlarged illustration of a portion of FIG. 7.

FIG. 8 is a block diagram of components of the vehicle and the lidar system.

### DETAILED DESCRIPTION

With reference to the Figures, wherein like numerals indicate like parts throughout the several views, a lidar system 20 includes a light detector 25 having a field of view FOV. The lidar system 20 includes one or more light emitters 27, 29. At least one of the one or more light emitters 27, 29 emits infrared light into the field of view FOV of the light detector 25 and at least one of the one or more light emitters 27, 29 emits visible light into the field of view FOV of the light detector 25.

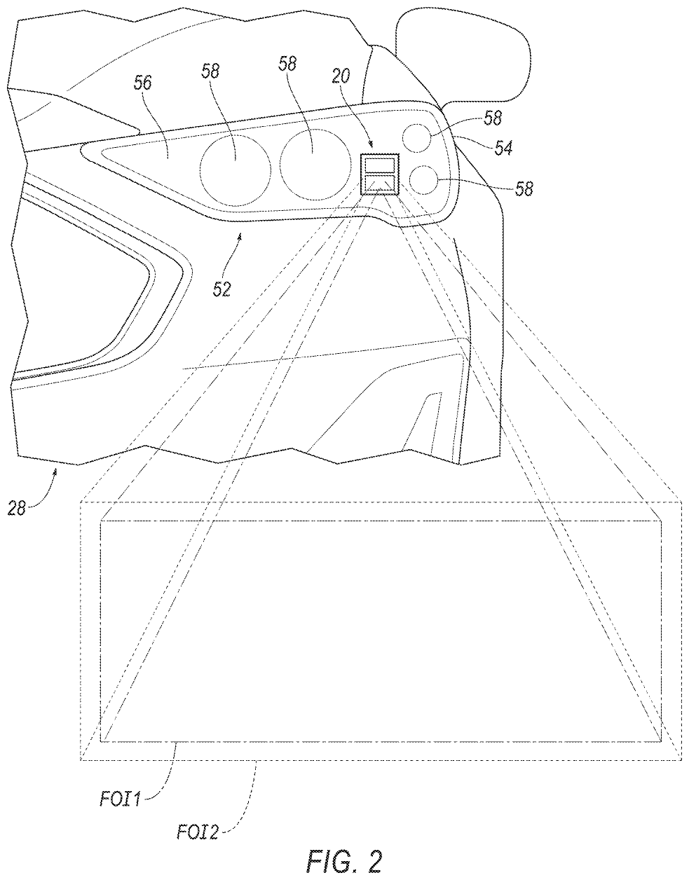

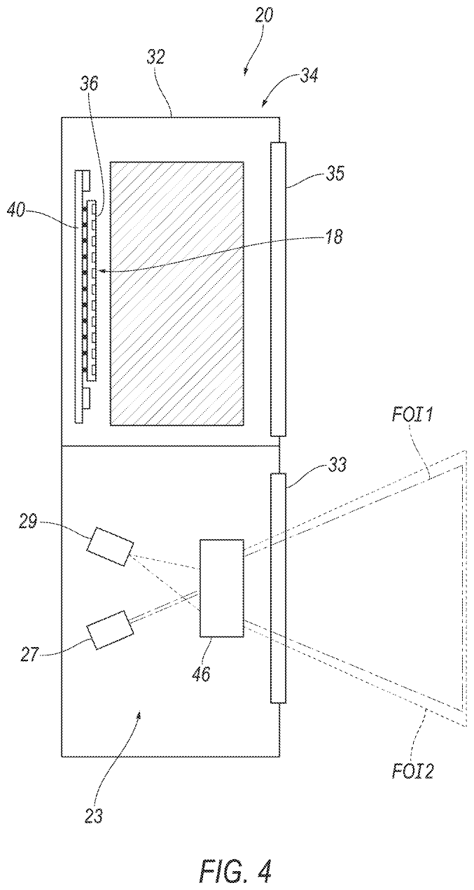

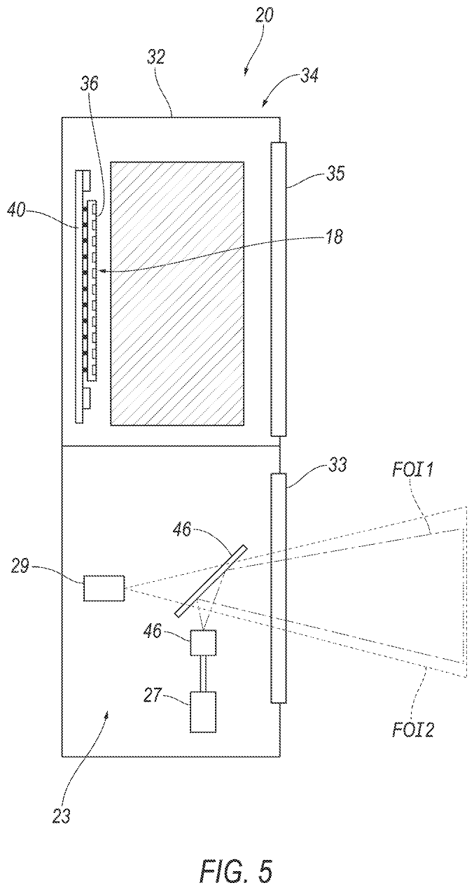

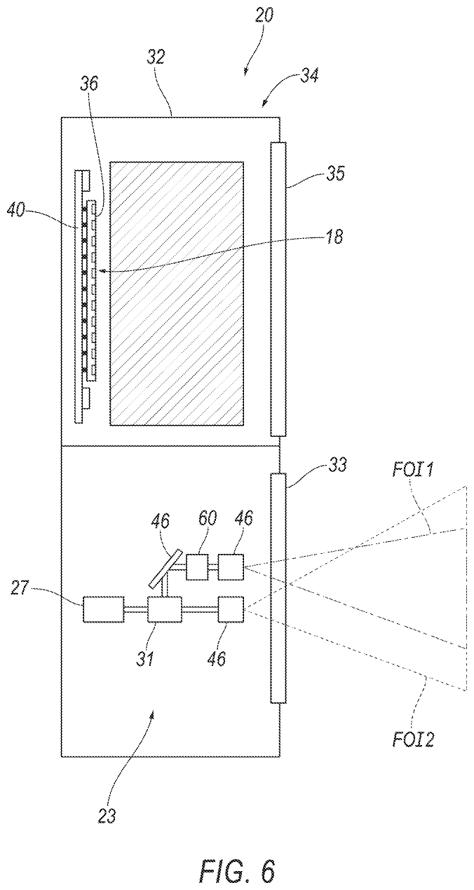

The visible light emitted from the lidar system 20 encourages eye aversion, e.g., by pedestrians, vehicle occupants, etc., to reduce the likelihood of eye exposure to the infrared light emitted by the lidar system 20. As an example, the lidar system 20 may be assembled to a vehicle 28, e.g., to provide data to an ADAS 30 of the vehicle 28 as described further below. In such an example, the infrared light is emitted and reflected back to the lidar system 20 by objects in the field of view FOV of the light detector for environmental mapping, as described further below. The visible light emitted by the lidar system 20 encourages eye aversion by occupants of other vehicles and pedestrians. In the example shown in FIG. 2, the lidar system 20 is assembled to a headlight assembly 52 of the vehicle 28. Alternatively, the lidar system 20 may be positioned in any location on the vehicle 28. As described further below, the lidar system 20 may include separate light emitters for the infrared light and the visible light, e.g., light emitter 27 emitting infrared light and light emitter 29 emitting visible light as shown in the examples of FIGS. 4 and 5. As another example, a single light emitter 27 may generate both the infrared light and the visible light, as shown in the example in FIG. 6. In such an example, the light emitter 27 may emit infrared light that energizes a phosphor 60 that emits visible light into the field of view FOV of the light detector 25.

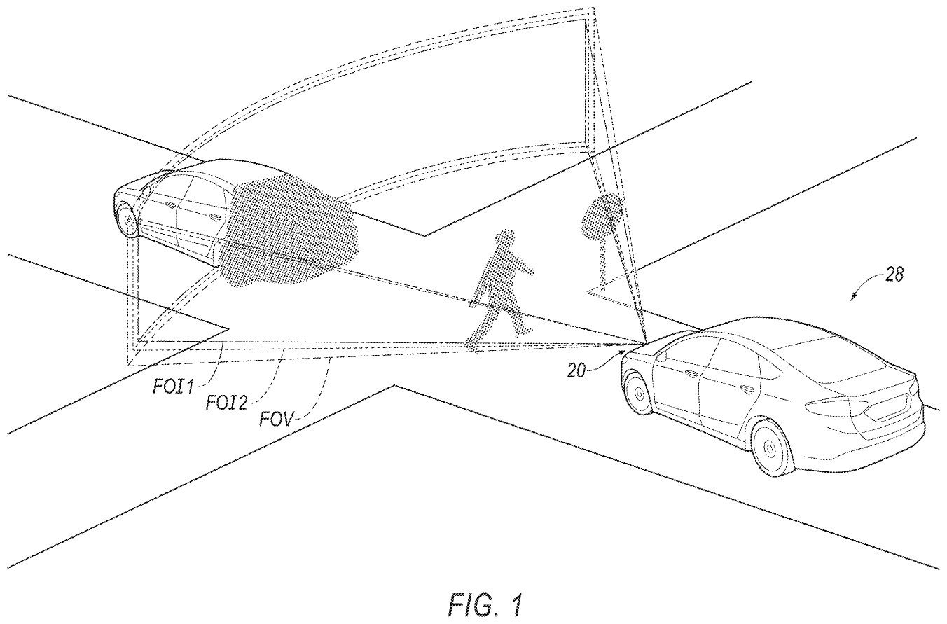

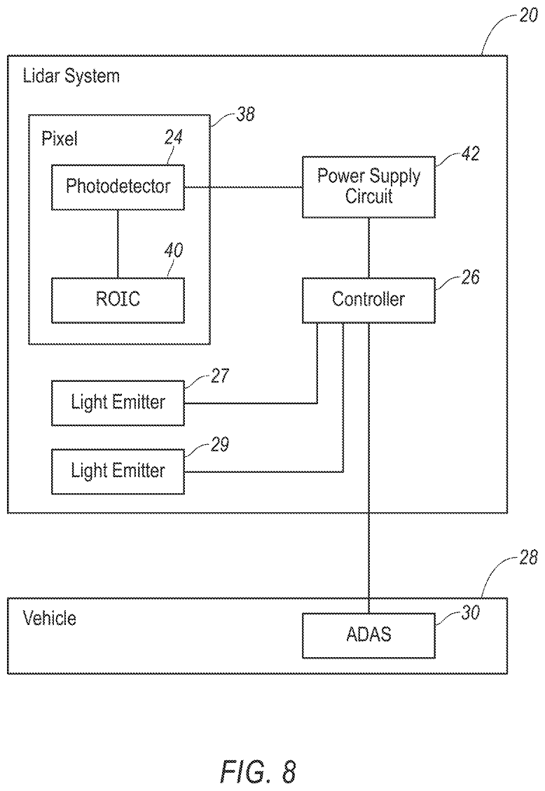

FIG. 1 shows an example vehicle 28. The lidar system 20 is mounted to the vehicle 28. In such an example, the lidar system 20 is operated to detect objects in the environment surrounding the vehicle 28 and to detect distances of those objects for environmental mapping. The output of the lidar system 20 may be used, for example, to autonomously or semi-autonomously control the operation of the vehicle 28, e.g., propulsion, braking, steering, etc. Specifically, the lidar system 20 may be a component of or in communication with an advanced driver-assistance system (ADAS) 30 of the vehicle 28 (FIG. 8). The lidar system 20 may be mounted on the vehicle 28 in any suitable position and aimed in any suitable direction. As one example shown in FIG. 2, the lidar system 20 is shown on the front of the vehicle 28 in the headlight assembly 52 and is directed forward. The vehicle 28 may have more than one lidar system 20 and/or the vehicle 28 may include other object detection systems, including other lidar systems 20. The vehicle 28 is shown in FIG. 1 as including a single lidar system 20 aimed in a forward direction merely as an example. In examples including more than one lidar system, any one or all of the lidar systems 20 may emit the visible light as described herein. The vehicle 28 shown in the Figures is a passenger automobile. As other examples, the vehicle 28 may be of any suitable manned or un-manned type including a plane, satellite, drone, watercraft, etc.

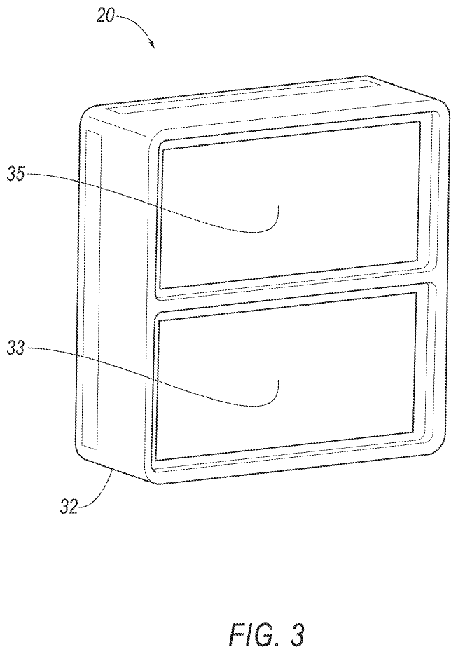

The lidar system 20 may be a solid-state lidar system 20. In such an example, the lidar system 20 is stationary relative to the vehicle 28. For example, the lidar system 20 may include a casing 32 (shown in FIGS. 3-6 and described below) that is fixed relative to the vehicle 28, i.e., does not move relative to the component of the vehicle 28 to which the casing 32 is attached, and a silicon substrate of the lidar system 20 is supported by the casing 32.

As a solid-state lidar system, the lidar system 20 may be a flash lidar system. In such an example, the lidar system 20 emits pulses of light into the field of illumination FOI (FIG. 1). More specifically, the lidar system 20 may be a 3D flash lidar system 20 that generates a 3D environmental map of the surrounding environment, as shown in part in FIG. 1. An example of a compilation of the data into a 3D environmental map is shown in the FOV and the field of illumination FOI1 in FIG. 1. A 3D environmental map may include location coordinates of points within the FOV with respect to a coordinate system, e.g., a Cartesian coordinate system with an origin at a predetermined location such as a GPS (Global Positioning System) reference location, or a reference point within the vehicle 28, e.g., a point where a longitudinal axis and a lateral axis of the vehicle 28 intersect.

In such an example, the lidar system 20 is a unit. With reference to FIGS. 3 and 4, the lidar system 20 may include the casing 32, an outer window 33, 35, a light receiving system 34, and a light emitting system 23. In such an example, the casing 32 supports the light emitter 27, 29 and the light detector 25, as shown in FIG. 4. In the example shown in FIG. 2 in which the lidar system 20 is assembled to the headlight assembly 52, the casing 32 and/or the outer window 33, 35 may be covered by a lens 56 of the headlight assembly 52 or may be exposed through the lens 56.

The casing 32, for example, may be plastic or metal and may protect the other components of the lidar system 20 from environmental precipitation, dust, etc. In the alternative to the lidar system 20 being a unit, components of the lidar system 20, e.g., the light emitting system 23 and the light receiving system 34, may be separate and disposed at different locations of the vehicle 28. The lidar system 20 may include mechanical attachment features to attach the casing 32 to the vehicle 28, e.g., to a case 54 of the headlight assembly 52, and may include electronic connections to connect to and communicate with electronic system of the vehicle 28, e.g., components of the ADAS.

The outer windows 33, 35 allows light to pass through, e.g., light generated by the light emitting system 23 exits the lidar system 20 through outer window 33 and light from environment enters the lidar system 20 through outer window 35. The outer window 33 receives light from the light emitter 27, 29 and transmits the light exterior to the casing 32. In other words, the outer window 33 may be referred to as an exit window. The outer window 33 may pass both the infrared light and the visible light generated by the light emitting system 23. The outer window 33 protects an interior of the lidar system 20 from environmental conditions such as dust, dirt, water, etc. The outer window 33 may be a transparent or semi-transparent material, e.g., glass, plastic. The outer window 33 may extend from the casing 32 and/or may be attached to the casing 32.

As set forth above, the lidar system 20 includes one or more light emitters 27, 29. At least one of the one or more light emitters 27, 29 emits infrared light into the field of view FOV1 of the light detector 25 and at least one of the one or more light emitters 27, 29 emits visible light into the field of view FOV2 of the light detector 25. In other words, in some examples the lidar system 20 includes more than one light emitter 27, 29 with at least one light emitter 27 emitting infrared light into the field of view FOV1 and at least one other light emitter 29 emitting visible light into the field of view FOV2, as shown in the examples in FIGS. 5 and 6; or the lidar system may include a single light emitter 27 that emits both infrared light and visible light into the field of view FOV1, FOV2.

With reference to FIGS. 2 and 4-6, the one or more light emitters 27 emits the infrared light in a first field of illumination FOI1 and the one or more light emitters (e.g., light emitter 29 in FIGS. 4-5 and light emitter 27 in FIG. 6) emits the visible light in a second field of illumination FOI2. The second field of illumination FOI2 overlaps the first field of illumination FOI1. This encourages eye aversion at the area of overlap. Specifically, the second field of illumination FOI2 may envelop the first field of illumination FOI1. Specifically, the second field of illumination FOI2 surrounds the first field of illumination FOI1 to ensure that visible light is emitted in all areas in which the infrared light is emitted.

With reference to FIGS. 2 and 4-6, the lidar assembly 20 may emit both the infrared light and the visible light from the outer window 33. Specifically, the light emitter 27, 29 and any optics are positioned to emit both the infrared light and the visible light through the outer window 33. Alternatively, the lidar assembly 20 may emit the infrared light and the visible light through separate outer windows.

With reference to FIGS. 4-6, the light emitter 27 that emits shots, i.e., pulses, of infrared light into the field of illumination FOI for detection by a light-receiving system 34 when the infrared light is reflected by an object in the field of view FOV. The light-receiving system 34 has a field of view (hereinafter “FOV”) that overlaps the field of illumination FOI2 and receives light reflected by surfaces of objects, buildings, road, etc., in the FOV. The light emitter 27 may be in electrical communication with a controller 26 of the lidar system 20, e.g., to provide the shots in response to commands from the controller 26.

The light emitter 27 may be a semiconductor light emitter, e.g., laser diodes. In one example, as shown in FIG. 3, the light emitter 27 may include a diode-pumped solid-state laser (DPSSL) emitter. In such an example the light emitter 27 may be an Nd:YAG laser. As another example, the light emitter 27 may include a vertical-cavity surface-emitting laser (VCSEL) emitter. As another example, the light emitter 27 may include an edge emitting laser emitter. The light emitter 27 may be designed to emit a pulsed flash of infrared light, e.g., a pulsed laser light. Specifically, the light emitter 27 is designed to emit a pulsed laser light. Each pulsed flash of light may be referred to as the “shot” as used herein. The lidar system 20 may include any suitable number of light emitters 27. In examples that include more than one light emitter 27, the light emitters 27 may be identical or different.

As set forth above, one light emitter 27 may emit both infrared light and visible light into the field of view of the light detector 25. Such an example is shown in FIG. 6. Specifically, in the example in FIG. 6, the lidar system 20 includes the light emitter 27 that emits both infrared light and visible light. Specifically, the lidar system 20 in the example in FIG. 6 may include a phosphor 60. Infrared light generated by the light emitter 27 in the lidar system 20 energizes the phosphor 60 causing the phosphor 60 to emit visible light. This visible light is emitted from the lidar system 20, e.g., through the outer window 33. The phosphor 60 may be of any suitable material that is energized by infrared light emitted from the light emitter 27.

The light emitter 29 may be any suitable type of light emitter that emits visible light. For example, the light emitter 29 may be a light-emitting diode (LED).

With reference to FIGS. 4-6, the light emitting system 23 may include one or more optical elements 46. The optical element 46 may be of any suitable type that shapes and/or directs light from the light emitter 27, 29 toward the outer window 33. In examples including two optical elements 27, 29, the light emitting system 23 may include separate optical elements 46 for the separate light emitters 27, 29. As another example, the light emitters 27, 29 may share one or more optical elements 46. As another example, the visible light from the light emitter 29 may exit the lidar system 20 without shaping or direction by an optical element. The optical element(s) 46 may be transmissive or reflective. For example, the optical element 46 may be or include a diffractive optical element, a diffractive diffuser, a refractive diffuser, a computer-generated hologram, a blazed grating, a beam expander, a collimating lens, etc.

The light emitter 27, 29 is aimed at the optical element 46. In other words, light from the light emitter 27, 29 is directed by the optical element 46, e.g., by transmission through/reflection by and shaping (e.g., diffusion, scattering, etc.) by the optical element 46. The light emitter 27, 29 may be aimed directly at the optical element 46 or may be aimed indirectly at the optical element 46 through intermediate reflectors/deflectors, diffusers, optics, etc.

The optical element 46 shapes light that is emitted from the light emitter 27, 29. Specifically, the light emitter 27, 29 is aimed at the optical element 27, 29, i.e., substantially all of the light emitted from the light emitter 27, 29 hits the optical element 46. The shaped light from the optical element 46 may travel directly to the outer window 33 or may interact with additional components between the optical element 46 the outer window 33 before exiting the outer window 33 into the field of illumination FOI.

The optical element 46 directs at least some of the shaped light, e.g., the large majority of the shaped light, to the outer window 33 for illuminating the field of illumination exterior to the lidar system 20. In other words, the optical element 46 is designed to direct at least some of the shaped light to the outer window 33, i.e., is sized, shaped, positioned, and/or has optical characteristics to direct at least some of the shaped light to the outer window 33.

In the example shown in FIG. 4, both light emitters 27, 29 are aimed at a common optical element 46, which diffuses and directs the infrared light and the visible light through the outer window 33. In the example shown in FIG. 5, the lidar system 20 includes two optical elements 46 for the light emitter 27. These optical elements 46 diffuse and direct light the infrared light through the outer window 33. In the example shown in FIG. 5, the light emitter 29 directs the visible light directly through the outer window 33 without interaction with an optical element. In the example shown in FIG. 6, the light emitter 27 emits infrared light. A beam splitter 31 directs some of the infrared light through the outer window 33 (after diffusion by an optical element 46) and directs some of the light to the phosphor 60 (e.g., with an intermediate other optical element 46). The infrared light energizes the phosphor 60, which emits visible light. This visible light is directed through the outer window 33 (e.g., with an intermediate optical element).

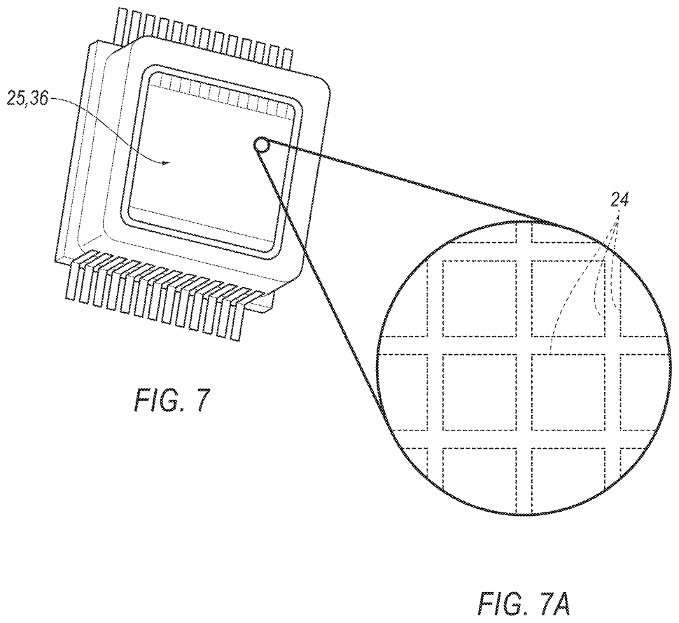

With reference to FIGS. 4-7, the light-receiving system 34 detects infrared light, e.g., emitted by the light emitter 27. The light-receiving system 34 includes the light detector 25. The light detector 25 may include at least one photodetector 24. For example, the light detector 25 may be a focal-plane array (FPA) 36. The FPA 36 can include an array of pixels 38. Each pixel 38 can include at least one photodetector 24 and a read-out circuit (ROIC) 40. A power-supply circuit (not numbered) may power the pixels 38. The FPA 36 may include a single power-supply circuit in communication with all photodetectors 24 or may include a plurality of power-supply circuits in communication with a group of the photodetectors 24. The light-receiving system 34 may include receiving optics such as a lens package. The light-receiving system 34 may include an outer window 35 and the receiving optics may be between the receiving outer window 35 and the FPA 36. The outer window 35 of the light-receiving system 34 be separate from the outer window 33 of the light-emitting system 23, as shown FIGS. 2-3, or the outer windows 33, 35 may be one piece of material. The pixel 38 reads to a histogram. The pixel 38 can include one photodetector 24 that reads to a histogram or a plurality of photodetectors 24 that each read to the same histogram. In the event the pixel 38 includes multiple photodetectors 24, the photodetectors 24 may share chip architecture.

The FPA 36 detects photons by photo-excitation of electric carriers, e.g., with the photodetectors 24. An output from the FPA 36 indicates a detection of light and may be proportional to the amount of detected light. The outputs of FPA 36 are collected to generate a 3D environmental map, e.g., 3D location coordinates of objects and surfaces within FOV of the lidar system 20. The FPA 36 may include the photodetectors 24, e.g., that include semiconductor components for detecting infrared reflections from the FOV of the lidar system 20. The photodetectors 24, may be, e.g., photodiodes (i.e., a semiconductor device having a p-n junction or a p-i-n junction) including avalanche photodetectors, metal-semiconductor-metal photodetectors, phototransistors, photoconductive detectors, phototubes, photomultipliers, etc. Optical elements of the light-receiving system 34 may be positioned between the FPA 36 in the back end of the casing 32 and the outer window 35 on the front end of the casing 32.

With continued reference to FIG. 4-7, the ROIC 40 converts an electrical signal received from photodetectors 24 of the FPA 36 to digital signals. The ROIC 40 may include electrical components which can convert electrical voltage to digital data. The ROIC 40 may be connected to a controller 26 of the lidar system 20, which receives the data from the ROIC 40 and may generate 3D environmental map based on the data received from the ROIC 40. The ROIC may be integrated jointly with the FPA and/or the controller 26 of the lidar system 20 into one single integrated circuit or component.

Each pixel 38 may include one photodetector 24, e.g., an avalanche-type photodetector (as described further below), connected to the power-supply circuits. Each power-supply circuit may be connected to one of the ROICs 40. Said differently, each power-supply circuit may be dedicated to one of the pixels 38 and each read-out circuit 40 may be dedicated to one of the pixels 38. Each pixel 38 may include more than one photodetector 24 (for example, two avalanche-type photodetectors).

The pixel 38 functions to output a single signal or stream of signals corresponding to a count of photons incident on the pixel 38 within one or more sampling periods. Each sampling period may be picoseconds, nanoseconds, microseconds, or milliseconds in duration. The pixel 38 can output a count of incident photons, a time between incident photons, a time of incident photons (e.g., relative to an illumination output time), or other relevant data, and the lidar system 20 can transform these data into distances from the system to external surfaces in the fields of view of these pixels 38. By merging these distances with the position of pixels 38 at which these data originated and relative positions of these pixels 38 at a time that these data were collected, the controller 26 of the lidar system 20 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

The pixels 38 may be arranged as an array, e.g., a 2-dimensional (2D) or a 1-dimensional (1D) arrangement of components. A 2D array of pixels 38 includes a plurality of pixels 38 arranged in columns and rows.

The photodetector 24 may be an avalanche-type photodetector. For example, the photodetector 24 may be operable as a single-photon avalanche diode (SPAD) based on the bias voltage applied to the photodetector 24. To function as the SPAD, the photodetector 24 operates at a bias voltage above the breakdown voltage of the semiconductor, i.e., in Geiger mode. Accordingly, a single photon can trigger a self-sustaining avalanche with the leading edge of the avalanche indicating the arrival time of the detected photon. In other words, the SPAD is a triggering device.

The power-supply circuit supplies power to the photodetector 24. The power-supply circuit may include active electrical components such as MOSFET (Metal-Oxide-Semiconductor Field-Effect Transistor), BiCMOS (Bipolar CMOS), etc., and passive components such as resistors, capacitors, etc. The power-supply control circuit may include electrical components such as a transistor, logical components, etc. The power-supply control circuit may control the power-supply circuit, e.g., in response to a command from a controller 26 of the lidar system 20, to apply bias voltage (and quench and reset the photodetectors 24 in the event the photodetector 24 is operated as a SPAD).

Data output from the ROIC 40 may be stored in memory, e.g., for processing by the controller 26 of the lidar system 20. The memory may be DRAM (Dynamic Random Access Memory), SRAM (Static Random Access Memory), and/or MRAM (Magneto-resistive Random Access Memory) electrically connected to the ROIC 40.

Infrared light emitted by the light emitter 27 may be reflected off an object back to the lidar system 20 and detected by the photodetectors 24. An optical signal strength of the returning infrared light may be, at least in part, proportional to a time of flight/distance between the lidar system 20 and the object reflecting the light. The optical signal strength may be, for example, an amount of photons that are reflected back to the lidar system 20 from one of the shots of pulsed light. The greater the distance to the object reflecting the light/the greater the flight time of the light, the lower the strength of the optical return signal, e.g., for shots of pulsed light emitted at a common intensity. As described above, the lidar system 20 generates a histogram for each pixel 38 based on detection of returned shots. The histogram may be used to generate the 3D environmental map.

The controller 26 of the lidar system 20 is shown in FIG. 8. The controller 26 of the lidar system 20 may be a microprocessor-based controller implemented via circuits, chips, or other electronic components. The controller 26 may include a processor and a memory. The controller 26 may include a programmable processor and/or a dedicated electronic circuit including an Application-Specific Integrated Circuit (ASIC) that is manufactured for a particular operation, e.g., an ASIC for determining gain control signal. In another example, a dedicated electronic circuit may include a Field-Programmable Gate Array (FPGA) which is an integrated circuit manufactured to be configurable by a customer. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging.

The controller 26 is in electronic communication with the pixels 38 (e.g., with the ROIC 40 and power-supply circuits) and the vehicle 28 (e.g., with the ADAS 30) to receive data and transmit commands. The controller 26 may be configured to execute operations disclosed herein. For example, in examples in which the controller 26 includes a processor and memory, the memory stores instructions executable by the processor to execute the operations disclosed herein and electronically stores data and/or databases. electronically storing data and/or databases. The memory includes one or more forms of computer-readable media, and stores instructions executable by the controller 26 for performing various operations, including as disclosed herein, for example the method 900 shown in FIG. 9. For example, the controller 26 may include a dedicated electronic circuit including an ASIC (Application Specific Integrated Circuit) that is manufactured for a particular operation, e.g., calculating a histogram of data received from the lidar system 20 and/or generating a 3D environmental map for a Field of View (FOV) of the vehicle 28. In another example, the controller 26 may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. The controller 26 may be a set of computers communicating with one another via the communication network of the vehicle 28, e.g., a computer in the lidar system 20 and a second computer in another location in the vehicle 28.

The vehicle 28 may include a computer that operates the vehicle 28 in an autonomous, a semi-autonomous mode, or a non-autonomous (or manual) mode. For purposes of this disclosure, an autonomous mode is defined as one in which each of vehicle propulsion, braking, and steering are controlled by the computer; in a semi-autonomous mode the computer controls one or two of vehicle propulsion, braking, and steering; in a non-autonomous mode a human operator controls each of vehicle propulsion, braking, and steering.

The computer of the vehicle 28 may be programmed to, based on input from the lidar system 20, operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer, as opposed to a human operator, is to control such operations. Additionally, the computer may be programmed to determine whether and when a human operator is to control such operations.

The controller 26 of the lidar system 20 may include or be communicatively coupled to, e.g., via a vehicle 28 communication bus, more than one processor, e.g., controllers or the like included in the vehicle for monitoring and/or controlling various vehicle controllers, e.g., a powertrain controller, a brake controller, a steering controller, etc. The controller 26 is generally arranged for communications on a vehicle communication network that can include a bus in the vehicle such as a controller area network (CAN) or the like, and/or other wired and/or wireless mechanisms.

The controller 26 of the lidar system 20 may be configured to emit the visible light simultaneously with the infrared light. This encourages eye aversion, as described above, during the emission of infrared light. In the example shown in FIGS. 4 and 5, the controller 26 instructs the light emitter 27 to emit infrared light and instructs the light emitter 29 to emit visible light simultaneously with the emission of the infrared light.

As set forth above, and with reference to FIG. 2, the lidar system 20 may be assembled to a headlight assembly 52 of the vehicle 28. The headlight assembly 52 may include a headlight case 54 that is mounted to the vehicle 28. The headlight case 54 may be fixed relative to the vehicle 28, e.g., may be rigidly fastened to a body of the vehicle 28. The headlight case 54 may be, for example, plastic. In examples in which the lidar system 20 is assembled to the headlight assembly 52, the lidar system 20 may be supported by the headlight case 54. Specifically, the casing 32 of the lidar system 20 may be fixed to the headlight case 54, e.g., by fastening, adhesive, unitary construction, etc.

The headlight assembly 52 includes a lens 56. The lens 56 is transparent and transmits light generated by the headlight assembly 52 to the exterior of the headlight assembly 52. As set forth above, the casing 32 and/or the outer window 33, 35 of the lidar assembly 20 may be covered by a lens 56 of the headlight assembly 52 or may be exposed through the lens 56. In any event, the infrared light and the visible light generated by the lidar assembly 20 is emitted into the field of view FOV of the light detector 25.

The headlight assembly includes at least one lamp 58 that is supported by the case 54 and emits visible light. In other words, the lamp 58 is a light source that emits visible light. The lamp 58 is enclosed between the headlight case 54 and the lens 56. The lamp 58 may be incandescent, LED, halogen, or any other suitable type of light source.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A lidar system comprising:
a light detector having a field of view;
one or more light emitters;
wherein at least one of the one or more light emitters emits infrared light into the field of view of the light detector and at least one of the one or more light emitters emits visible light into the field of view of the light detector.

2. The lidar system as set forth in claim 1, wherein the one or more light emitters emits the infrared light in a first field of illumination and the one or more light emitters emits the visible light in a second field of illumination overlapping the first field of illumination.

3. The lidar system as set forth in claim 1, wherein the one or more light emitters emits the infrared light in a first field of illumination and the one or more light emitters emits the visible light in a second field of illumination enveloping the first field of illumination.

4. The lidar system as set forth in claim 1, further comprising an outer window, the one or more light emitters emits the infrared light and the visible light through the outer window.

5. The lidar system as set forth in claim 4, further comprising a casing supporting the outer window and the one or more light emitters.

6. The lidar system as set forth in claim 5, wherein the casing supports the light detector.

7. The lidar system as set forth in claim 1, wherein the one or more light emitters includes a laser diode that emits the infrared light and a second light emitter that emits the visible light.

8. The lidar system as set forth in claim 1, wherein the one or more light emitters includes at least one light emitter that emits both the infrared light and the visible light.

9. The lidar system as set forth in claim 8, wherein the at least one light emitter includes a phosphor and a laser diode that emits infrared light at the phosphor.

10. The lidar system as set forth in claim 1, further comprising a controller configured to emit the visible light simultaneously with the infrared light.

11. A headlight assembly comprising:
a headlight case;
a lamp that is supported by the case and emits visible light; and
a lidar system supported by the headlight case;
the lidar system including a light detector having a field of view;
the lidar system including one or more light emitters;
wherein at least one of the one or more light emitters emits infrared light into the field of view of the light detector and at least one of the one or more light emitters emits visible light into the field of view of the light detector.

12. The headlight assembly as set forth in claim 11, wherein the one or more light emitters emit the infrared light in a first field of illumination and the one or more light emitters emit the visible light in a second field of illumination overlapping the first field of illumination.

13. The headlight assembly as set forth in claim 11, wherein the one or more light emitters emit the infrared light in a first field of illumination and the one or more light emitters emit the visible light in a second field of illumination enveloping the first field of illumination.

14. The headlight assembly as set forth in claim 11, wherein the lidar system includes an outer window, the one or more light emitters emits the infrared light and the visible light through the outer window.

15. The headlight assembly as set forth in claim 14, wherein the lidar system includes a casing supported on the headlight case, the casing supporting the outer window and the one or more light emitters.

16. The headlight assembly as set forth in claim 15, wherein the casing supports the light detector.

17. The headlight assembly as set forth in claim 11, wherein the one or more light emitters includes a laser diode that emits the infrared light and a second light emitter that emits the visible light.

18. The headlight assembly as set forth in claim 11, wherein the one or more light emitters includes at least one light emitter that emits both the infrared light and the visible light.

19. The headlight assembly as set forth in claim 18, wherein the at least one light emitter includes a phosphor and a laser diode that emits infrared light at the phosphor.

20. The headlight assembly as set forth in claim 11, wherein the lidar system includes a controller configured to emit the visible light simultaneously with the infrared light.
